(19) United States
(12) Patent Application Publication
(10) Pub. No.: US 2021/0376534 A1
(43) Pub. Date: Dec. 2, 2021

(54) CONNECTORS WITH CONTACTS FOR RF SIGNALS

(71) Applicant: Apple Inc., Cupertino, CA (US)

(72) Inventors: Darshan R. Kasar, San Francisco, CA (US); Jambu A. Jambulingam, Fremont, CA (US); Sivesh Selvakumar, Sunnyvale, CA (US)

(73) Assignee: Apple Inc., Cupertino, CA (US)

(21) Appl. No.: 17/223,996

(22) Filed: Apr. 6, 2021

Related U.S. Application Data
(60) Provisional application No. 63/032,885, filed on Jun. 1, 2020.

(51) Int. Cl. H01R 13/6591; H01R 13/6582

(52) U.S. Cl. CPC H01R 13/65914; H01R 13/6582

(57) ABSTRACT

High-speed connectors that simplify connectivity between electronic devices, are simple to use, and are readily manufactured. One example can simplify connectivity by including contacts for power, data, and one or more RF signals into a single connector. One example provides a connector receptacle having a tongue supporting contacts for data and power. A ground contact can encircle the tongue and a shield can be around the tongue, contacts, and ground contact. An RF contact can be positioned between the ground contact and the shield, such that the ground contact and shield provide RF shielding for the RF contact.

### CROSS REFERENCES TO RELATED APPLICATIONS

This application claims the benefit of U.S. provisional application No. 63/032,885, filed on Jun. 1, 2020, which is incorporated by reference.

### BACKGROUND

The number of types of electronic devices that are commercially available has increased tremendously the past few years and the rate of introduction of new devices shows no signs of abating. Devices such as tablet, laptop, desktop, and all-in-one computers, cell phones, storage devices, wearable-computing devices, portable media players, navigation systems, monitors, adapters, and others, have become ubiquitous.

The functionality of these devices has likewise greatly increased. This has led to increases in the number of connectors used to connect these devices to external devices. For example, an electronic device can include a connector for power and another for data. It can also include a connector for high-speed or radio-frequency (RF) data. At the same time, the demand for smaller and thinner devices continues unabated. As a result, reducing the number of connectors and simplifying device connectivity is at a premium.

The inclusion of circuits such as the radios can necessitate the use of high-speed data paths from one electronic device to another. High-speed connector structures, such as coaxial cable connectors, can be used. Coaxial connectors can include a shielded conductor terminating at each end in a connector insert or plug. Signals can then be conveyed from a first electronic device through a coaxial cable to a second electronic device.

But each additional connector further complicates matters for a user, as each different connection requires the user to track down and plug in another cable. Also, some connectors, such as coaxial connectors, can be difficult for some users to utilize due to the physical complexity of making a connection.

Also, some of these electronic devices can be manufactured in very high volumes. To meet demand for these products, it can be desirable that these connector receptacles and connector inserts be readily manufactured.

Thus, what is needed are RF connectors that reduce the number of connections needed for an electronic device, are simple to connect, and are readily manufactured.

### SUMMARY

Accordingly, embodiments of the present invention can provide RF connectors that reduce the number of connections needed for an electronic device, are simple to connect, and are readily manufactured. An illustrative embodiment of the present invention can provide high-speed connectors that reduce the number of connections needed for an electronic device by including an RF contact along with data contacts and power contacts. By combining these contacts into a single connector, separate connectors for each type of contact are no longer needed. In one example, a number of power and data contacts can be positioned on a top and bottom of a tongue between a ground pad and a frame. The ground pad can encircle the tongue behind the power and data contacts, while the frame can be positioned at a leading edge and front sides of the tongue. An RF contact can be located between the ground pad and a shield, where the shield surrounds the RF contact, the ground pad, and the power and data contacts. Insulating layers can be positioned to isolate the RF contact from both the ground pad and the shield. The power and data contacts can be shielded by the ground pad and the frame, while the RF contact can be shielded by the ground pad and the shield.

In another example, an RF contact can be placed in a center of a tongue. A ground pad can be placed around the tongue, while a shield can be placed around the tongue and around the ground pad. Power and data contacts can be positioned on the tongue between the ground pad and the shield. An insulating layer can be placed between the RF contact and the ground pad. The ground pad can shield the RF contact while the ground pad and the shield can provide shielding for the power and data contacts.

In another example, a tongue can be surrounded by a shield. The tongue can include a single RF contact on a top side and a single ground contact on a bottom side.

These and other embodiments of the present invention can provide high-speed connectors that are simple to connect. One example can provide connectors that are based on Universal Serial Bus Type-C connectors. A connector receptacle can include a tongue having power and data contacts , side ground contacts, and a ground pad that are the same as or similar to those of a Universal Serial Bus (USB) Type-C connector. This can give a user a similar feel and experience as using a conventional USB Type-C connector. Another example can provide a connector having a tongue supporting an RF contact and a ground contact that is simple to connect as compared to a conventional coaxial connector.

These and other embodiments of the present invention can provide high-speed connectors that readily manufactured. One example can provide connectors that are based on Universal Serial Bus Type-C connectors. By utilizing aspects of a conventional connector, tooling and manufacturing processes can be simplified, design times can be shortened, and manufacturing experience can be leveraged.

These and other embodiments of the present invention can provide RF contacts that can convey various types of high-frequency signals. For example, these RF contacts can convey Intermediate Frequency (IF) signals, millimeter wave (mmW, mmWave, or MMW) signals (in the range of 30 GHz to 300 GHz), and other RF signals. Millimeter wave signals can be highly directional and have limited over-the-air propagation. As a result, the alignment of an RF contact in a connector insert to a corresponding RF contact in a connector receptacle can be important. Also for improved signal propagation, the dimensions of the RF contact, the materials used for the RF contact and dielectric, the surface roughness of the RF contact, and the spacing to shields or ground contacts can be tuned. Other contacts, such as power, ground, and signal contacts can be placed away from the RF contact and shielded to avoid interference. The RF signal can be routed though the connectors to a flexible circuit board, printed circuit board, or other appropriate substrate. These boards can further include tuning elements to improve signal propagation from a first electronic device to a second electronic device.

In these and other embodiments of the present invention, contacts, ground contacts, ground shields, and other conductive portions of a high-speed connector can be formed by stamping, metal-injection molding, machining, micro-machining, 3-D printing, or other manufacturing process. The conductive portions, such as the shields, ground pads, and RF contacts can be formed of stainless steel, steel, copper, copper titanium, phosphor bronze, or other material or combination of materials. They can be plated or coated with nickel, gold, or other material. The nonconductive portions, such as the insulating layers can be formed using injection or other molding, 3-D printing, machining, or other manufacturing process. The nonconductive portions can be formed of silicon or silicone, rubber, hard rubber, plastic, nylon, liquid-crystal polymers (LCPs), or other nonconductive material or combination of materials. Boards can be formed using FR-4 or other appropriate material.

These and other embodiments of the present invention can provide high-speed connectors that can be located in various types of devices, such as portable computing devices, tablet computers, desktop computers, laptops, all-in-one computers, cell phones, wearable-computing devices, storage devices, portable media players, navigation systems, monitors, power supplies, adapters, remote control devices, audio devices, chargers, and other devices. These high-speed connectors can provide pathways for signals that are compliant with various standards such as Universal Serial Bus (USB), a High-Definition Multimedia Interface (HDMI), Digital Visual Interface (DVI), power, Ethernet, DisplayPort, Thunderbolt, Lightning and other types of standard and non-standard interfaces that have been developed, are being developed, or will be developed in the future.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system that can be improved by the incorporation of an embodiment of the present invention;

FIG. 2 illustrates a connector receptacle according to an embodiment of the present invention;

FIG. 3 illustrates a cutaway side view of the connector receptacle FIG. 2;

FIGS. 4A illustrates a front view of the connector receptacle of FIG. 2;

FIGS. 4B illustrates an alternative front view of the connector receptacle of FIG. 2;

FIG. 5 illustrates another connector receptacle according to an embodiment of the present invention;

FIG. 6 illustrates a cutaway side view of the connector receptacle of FIG. 5;

FIG. 7A illustrates a front view of the connector receptacle of FIG. 5;

FIG. 7B illustrates an alternative front view of the connector receptacle of FIG. 5;

FIG. 8 illustrates a connector receptacle according to an embodiment of the present invention;

FIG. 9 illustrates a pinout that can be utilized to convey multiple RF or high-frequency signals according to an embodiment of the present invention;

FIG. 10 illustrates another pinout that can be utilized to convey an RF or high-frequency signal according to an embodiment of the present invention;

FIG. 11 illustrates another pinout that can be utilized to convey one or more RF or high-frequency signals according to an embodiment of the present invention;

FIG. 12 illustrates a connector insert that can be utilized with a connector receptacle according to an embodiment of the present invention;

FIG. 13 illustrates a front view of the connector insert of FIG. 12;

FIG. 14 illustrates a side view of the connector receptacle of FIG. 8 mated with the connector insert of FIG. 12;

FIG. 15 illustrates a connector receptacle according to an embodiment of the present invention;

FIG. 16 illustrates a front view of the connector receptacle of FIG. 15;

FIG. 17 illustrates a connector insert that can be mated with the connector receptacle of FIG. 15; and

FIG. 18 illustrates a front view of the connector insert of FIG. 17.

### DESCRIPTION OF ILLUSTRATIVE EMBODIMENTS

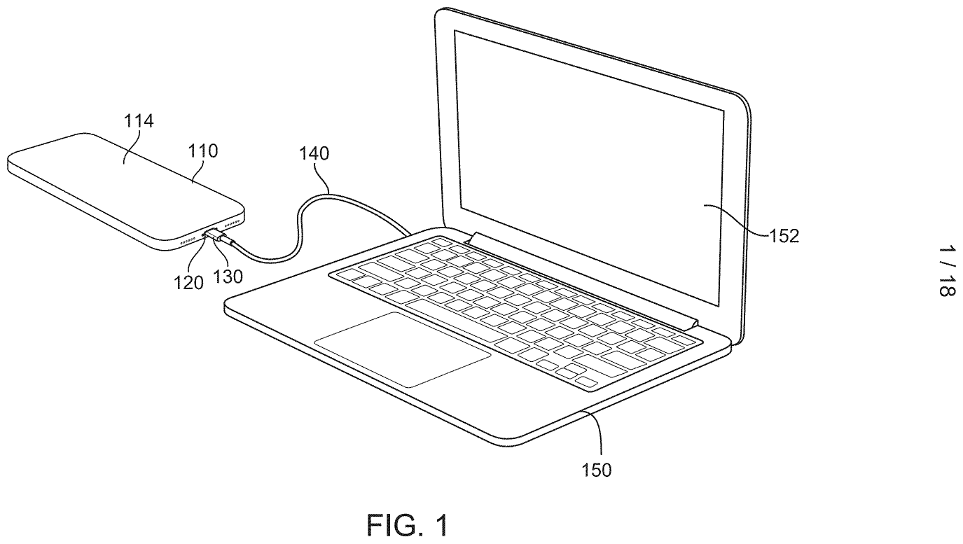

FIG. 1 illustrates an electronic system that can be improved by the incorporation of an embodiment of the present invention. This figure, as with the other figures, is shown for illustrative purposes and does not limit either the embodiments of the present invention or the claims.

This figure illustrates first electronic device 110 sharing power and data with second electronic device 150 over cable 140. Cable 140 can include connector plug or connector insert 130 that is plugged into connector receptacle 120 in first electronic device 110. Cable 140 can further include a second connector insert (not shown), which can be plugged into a corresponding connector receptacle (not shown) in second electronic device 150. First electronic device 110 is shown as a cell phone and can alternatively be a portable computing device, tablet computer, desktop computer, laptop computer, all-in-one computer, cell phone, wearable-computing device, storage device, portable media player, navigation system, monitor, power supply, adapter, remote control device, audio device, charger, or other device or portions of a device. First electronic device 110 can include display 114 and other components. Second electronic device 150 is shown as a laptop computer and can alternatively be a portable computing device, tablet computer, desktop computer, all-in-one computer, cell phone, wearable-computing device, storage device, portable media player, navigation system, monitor, power supply, adapter, remote control device, audio device, charger, or other device or portions of a device. Second electronic device 150 can include display 152 and other components.

First electronic device 110 and second electronic device 150 can share or transfer power over cable 140. First electronic device 110 and second electronic device 150 can also or instead share data. In some circumstances it can be desirable that one device be able to transfer data to the other at a very high rate. In various electronic systems, such a high data rate might be achievable using RF signals over a coaxial or other type cable. But coaxial cables are typically not able to convey power or other data signals. Accordingly, embodiments of the present invention can provide connector inserts and connector receptacles that can be used as connector insert 130 and connector receptacle 120 and that can convey RF signals along with power and other data signals. Examples are shown in the following figures.

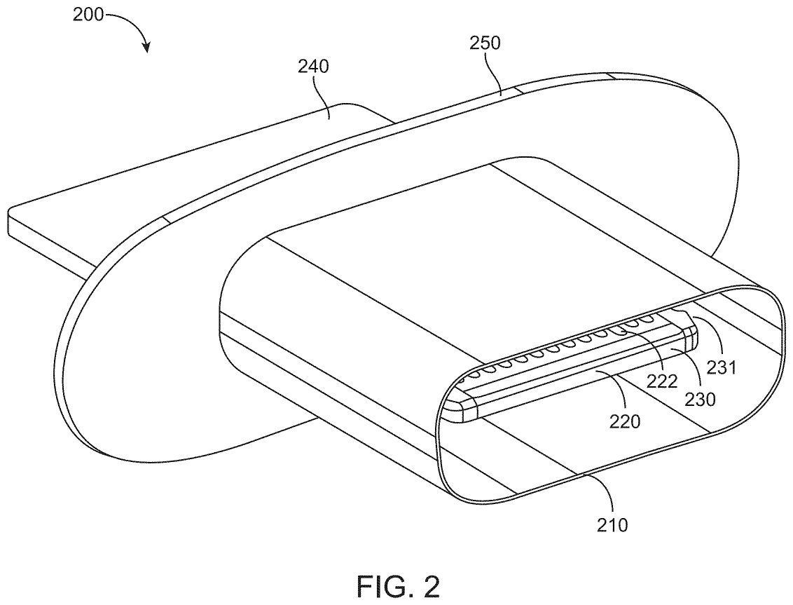

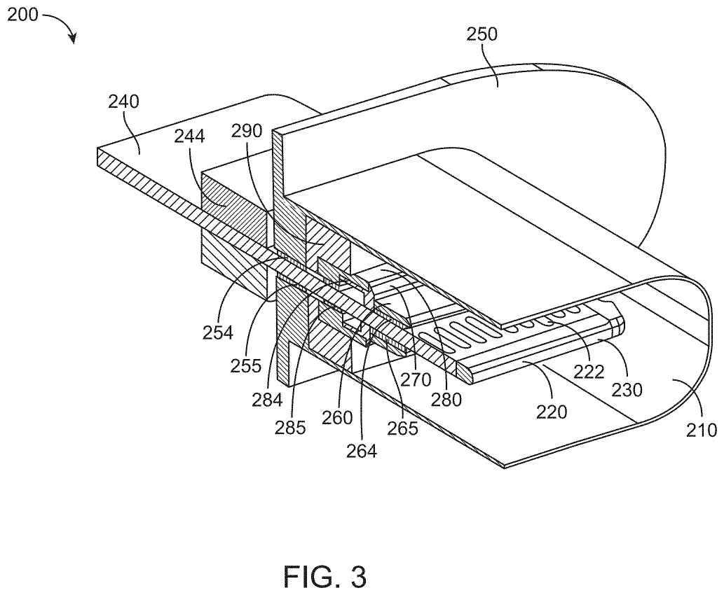

FIG. 2 illustrates a connector receptacle according to an embodiment of the present invention. Connector receptacle 200 can be used as connector receptacle 120 (shown in FIG. 1) above, or as a connector receptacle in other devices that can be improved by in the corporation of an embodiment of the present invention. Connector receptacle 200 can be based on a Universal Serial Bus Type-C connector receptacle. For example, connector receptacle 200 can include tongue 220 having power and data contacts 222, side ground contacts 231, ground pad 260 (shown in FIG. 3), and shield 210 that are the same as or similar to those of a Universal Serial Bus (USB) Type-C connector. This can give a user a similar feel and experience as using a conventional USB Type-C connector.

Connector receptacle 200 can include tongue 220 surrounded by shield 210. Tongue 220 can support contacts 222 on a top side of the tongue and a corresponding set of contacts (not shown) on a bottom side of the tongue. Tongue 220 can be formed by board 240. Board 240 can include traces to connect contacts 222 to circuitry and components 244 (shown in FIG. 3) of connector receptacle 200 and circuitry and components (not shown) in an electronic device (not shown) housing connector receptacle 200. A front portion of board 240 can be protected by frame 230. Frame 230 can be located along a front edge of tongue 220, as well as first and second sides of tongue 220, where the sides are between the top and bottom of tongue 220. Shield 210 can include back plate 250. Back plate 250 can assist in electrically connecting connector receptacle 200 to a device enclosure (not shown) for the electronic device housing connector receptacle 200. Shield 210 and back plate 250 can be formed as a single or as separate pieces.

Contacts 222 can convey power, ground, and data signals between connector receptacle 200 and a corresponding connector insert (not shown.) Again, it can be desirable to convey an RF signal between connector receptacle 200 and the corresponding connector insert. Accordingly, connector receptacle 200 can include one or more additional RF contacts to convey one or more RF signals. An example is shown in the following figure.

FIG. 3 illustrates a cutaway side view of the connector receptacle FIG. 2. Connector receptacle 200 can include tongue 220 surrounded by shield 210. Tongue 220 can support contacts 222 on a top side of the tongue, and a corresponding set of contacts (not shown) on a bottom side of tongue 220. Tongue 220 can be formed by board 240. Board 240 can include traces to connect contacts 222 to circuitry and components 244 located on board 240 and to other circuits and components (not shown) located in an electronic device (not shown) housing connector receptacle 200. A front portion of board 240 can be protected by frame 230. Frame 230 can be located along the front edge of tongue 220 as well as first and second sides of tongue 220, where the sides are between the top and bottom of tongue 220. Contacts 222 can convey power, ground, and data signals between connector receptacle 200 and a corresponding connector insert (not shown.)

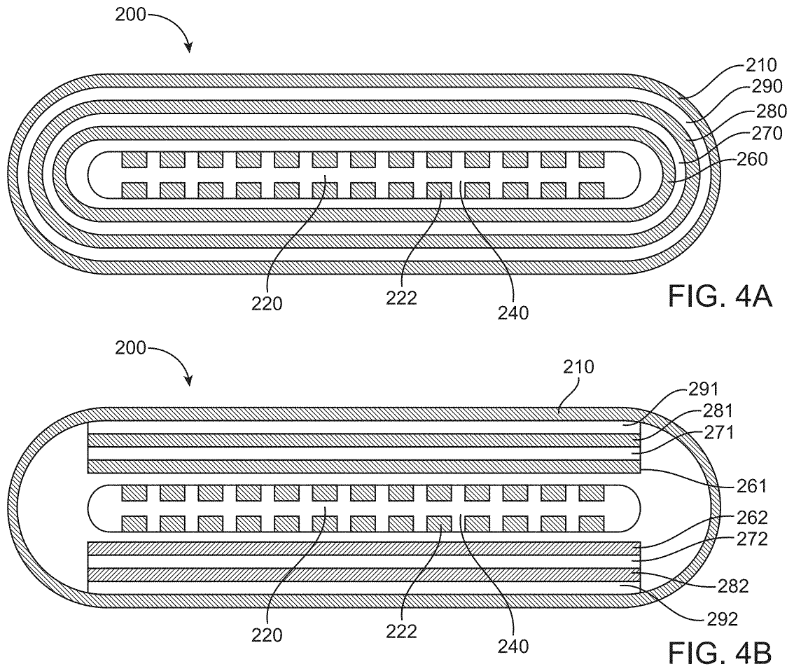

Ground pad 260 can encircle tongue 220. Ground pad 260 can be positioned such that contacts 222 are between ground pad 260 and frame 230 at a front edge of tongue 220. Ground pad 260 can extend around tongue 220 to the bottom side of tongue 220. In this example, ground pad 260 can be a single ground pad that encircles board 240. Alternatively, ground pad 260 can be split into top ground pad segment 261 and bottom ground pad segment 262, as shown in FIG. 4B. When top ground pad segment 261 and bottom ground pad segment 262 are separate ground pad segments, they can be joined or electrically connected, for example by vias (not shown) through board 240 or by side plating on edges (not shown) of board 240.

Ground pad 260 and frame 230 can shield contacts 222. Board 240 can include plated area 264 that can electrically connect ground pad 260. A similar plated area 265 can be located on a bottom side of tongue 220. Plated area 264 and plated area 265 can be connected through pads and traces of board 240 to ground or other voltage potential.

RF contact 280 can be positioned between ground pad 260 and shield 210. RF contact 280 can encircle tongue 220 and can extend to a bottom side of tongue 220. In this example, RF contact 280 can be a single RF contact that encircles board 240. Alternatively, RF contact 280 can be split into top RF contact segment 281 and bottom RF contact segment 282, as shown in FIG. 4B. When top RF contact segment 281 and bottom RF contact segment 282 are separate RF contact segments, they can be joined or electrically connected, for example by vias (not shown) through board 240 or by side plating on edges (not shown) of board 240.

Ground pad 260 and shield 210 can shield RF contact 280. Board 240 can include plated area 284 that can electrically connect to RF contact 280. A similar plated area 285 can be located on a bottom side of tongue 220. Plated area 284 and plated area 285 can be connected through pads and traces of board 240 to an RF receiver, transmitter, transceiver, or other circuit (not shown.) Board 240 can include plated area 254 that can electrically connect to shield 210 and back plate 250. A similar plated area 255 can be located on a bottom side of tongue 220. Plated area 254 and plated area 255 can be connected through pads and traces of board 240 to ground or other voltage potential.

Insulating layer 270 can isolate RF contact 280 from ground pad 260. Insulating layer 290 can isolate RF contact 280 from shield 210. Shield 210 can include back plate 250. Back plate 250 can assist in electrically connecting connector receptacle 200 to a device enclosure (not shown) for the electronic device housing connector receptacle 200. Shield 210 and back plate 250 can be formed as a single or as separate pieces.

These and other embodiments of the present invention can provide RF contact 280 that can convey various types of high-frequency signals. For example, RF contact 280 can convey Intermediate Frequency (IF) signals, millimeter wave (mmW, mmWave, or MMW) signals (in the range of 30 GHz to 300 GHz), and other RF signals. Millimeter wave signals can be highly directional and have limited over-the-air propagation. As a result, the alignment of RF contact 280 to a corresponding RF contact (not shown) in a connector insert (not shown) can be important. Also for improved signal propagation, the dimensions of RF contact 280, the materials used for RF contact 280, insulating layer 270, and insulating layer 290, the surface roughness of RF contact 280, and the spacing to shield 210 and ground pad 260 can be tuned. Other contacts, such as power, ground, and signal contacts 222 can be placed away from RF contact 280 and shielded to avoid interference. The RF signal can be routed though connector receptacle 200 to board 240, which can be a flexible circuit board, printed circuit board, or other appropriate substrate. Board 240 and other associated boards (not shown) can further include tuning elements to improve signal propagation from a first electronic device (not shown) to a second electronic device (not shown.)

FIG. 4A illustrates a front view of the connector receptacle of FIG. 2. Ground pad 260 can encircle tongue 220 of connector receptacle 200, which can include board 240. Board 240 can support contacts 222 on a top and bottom sides. RF contact 280 can encircle tongue 220 and can be separated from ground pad 260 by insulating layer 270. Shield 210 can be placed around RF contact 280, ground pad 260, and tongue 220. Insulating layer 290 can electrically isolate shield 210 from RF contact 280.

FIG. 4B illustrates an alternative front view of the connector receptacle of FIG. 2. In FIG. 4B, ground pad 260 (shown in FIG. 4A) can be separated into top ground pad segment 261 and bottom ground pad segment 262. Similarly, RF contact 280 (shown in FIG. 4A) can be split into top RF contact segment 281 and bottom RF contact segment 282. Tongue 220 can include board 240 supporting contacts 222 on top and bottom sides. Top ground pad segment 261 can be located over board 240, while bottom ground pad segment 262 can be located under tongue 220. Top RF contact segment 281 can be located over top ground pad segment 261, while bottom RF contact segment 282 can be located under bottom ground pad segment 262. Shield 210 can encircle tongue 220. Insulating layer 271 can isolate top RF contact segment 281 from top ground pad segment 261, insulating layer 272 can isolate bottom RF contact segment 282 from bottom ground pad segment 262, insulating layer 291 can isolate top RF contact segment 281 from shield 210, while insulating layer 292 can isolate bottom RF contact segment 282 from shield 210 of connector receptacle 200.

In this example, top RF contact segment 281 and bottom RF contact segment 282 can be formed separately. These two structures can be electrically connected, for example, by plating (not shown) on sides of board 240 or by vias (not shown) through board 240. Similarly, top ground pad segment 261 and bottom ground pad segment 262 can be formed separately. These two structures can be electrically connected, for example, by plating (not shown) on sides of board 240 or by vias (not shown) through board 240.

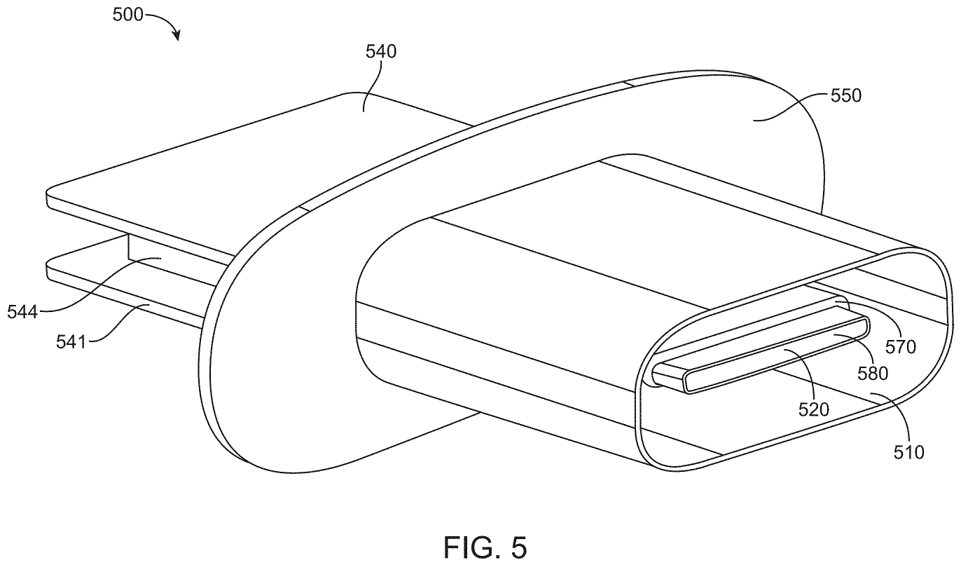

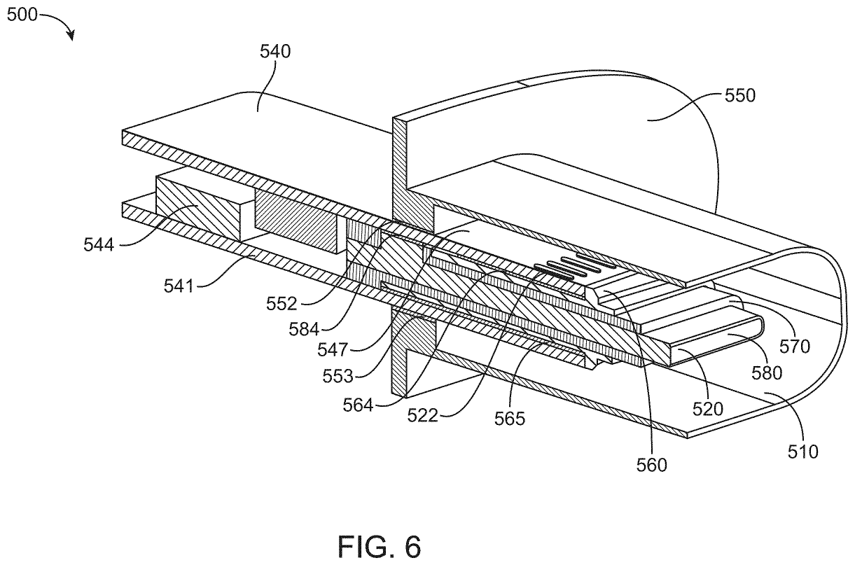

FIG. 5 illustrates another connector receptacle according to an embodiment of the present invention. Connector receptacle 500 can be used as connector receptacle 120 (shown in FIG. 1) above, or as a connector receptacle in other devices that can be improved by in the corporation of an embodiment of the present invention. Connector receptacle 500 can be based on a Universal Serial Bus Type-C connector receptacle. For example, connector receptacle 500 can include tongue 520 having power and data contacts 522 (shown in FIG. 6), and shield 510 that are the same as or similar to those of a Universal Serial Bus (USB) Type-C connector. This can give a user a similar feel and experience as using a conventional USB Type-C connector.

Connector receptacle 500 can include tongue 520 surrounded by shield 510. Shield 510 can include back plate 550. Back plate 550 can be used to electrically connect shield 510 to a device enclosure (not shown) for an electronic device (not shown) housing connector receptacle 500. Shield 210 and back plate 250 can be formed as a single or as separate pieces. Tongue 520 can include RF contact 580. RF contact 580 can be isolated from ground pad 560 by insulating layer 570. Board 540 and board 541 can form portions of tongue 520 and can support one or more circuits or components 544. Board 540 and board 541 can also support one or more connectors or other interconnect paths (not shown) to other circuits and components (not shown) of the electronic device housing connector receptacle 500.

FIG. 6 illustrates a cutaway side view of the connector receptacle of FIG. 5. Connector receptacle 500 can include tongue 520 surrounded by shield 510. Shield 510 can include back plate 550. Back plate 550 can be used to electrically connect shield 510 to a device enclosure (not shown) for an electronic device (not shown) housing connector receptacle 500. Tongue 520 can include RF contact 580. RF contact 580 can be isolated from ground pad 560 by insulating layer 570. Tongue 520 can also include board 540 and board 541. Board 540 and board 541 can support contacts 522 on a top and bottom side of tongue 520, respectively. Boards 540 can also support one or more circuits or components 544, as well as one or more connectors or other interconnect paths (not shown) to other circuits or components in the electronic device housing connector receptacle 500.

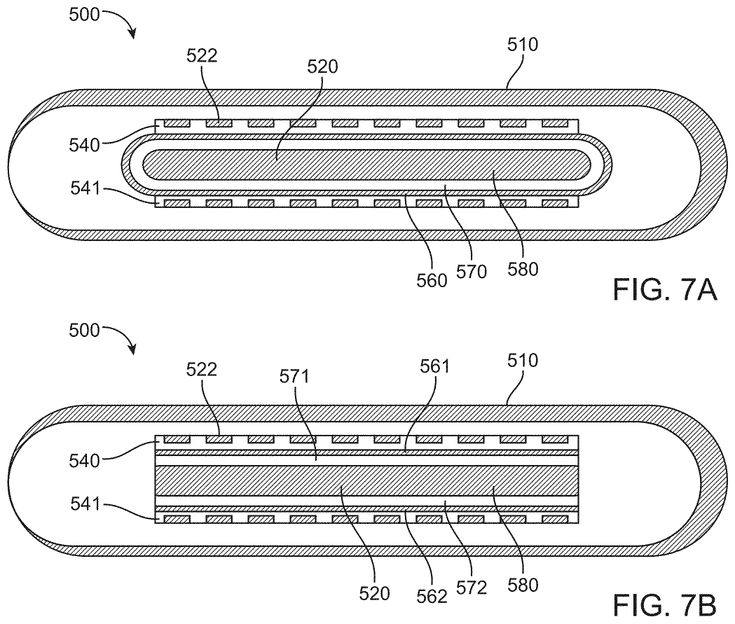

Similar to the above examples, ground pad 560 can encircle tongue 520 as a single piece. Alternatively, ground pad 560 can be formed of a top ground pad segment 561 (shown in FIG. 7B) and a bottom ground pad segment 562 (shown in FIG. 7B.) When top ground pad segment 561 and bottom ground pad segment 562 are separate ground pad segments, they can be joined or electrically connected, for example by vias (not shown) through boards 540 and 541 or by side plating on edges (not shown) of boards 540 and 541.

Additional ground contacts (not shown) can be placed at location 547 on a top side of tongue 520 and a corresponding position on a bottom side of tongue 520. These additional ground pads can be formed as part of shield 510 and back plate 550, or they can be separate ground contacts. The additional ground contacts can be formed as individual segments on a top of board 540 and a bottom of board 541, or they can be formed as a single piece encircling tongue 520. When these additional ground contacts are formed as individual segments, they can be connected together using side plating (not shown), vias (not shown), or other structures on or through tongue 520.

In this configuration, ground pad 560 can shield RF contact 580. Also, ground pad 560 and shield 510 can provide shielding for power, ground, and data or signal contacts 522. Ground pad 560 can electrically connect to pads or traces on boards 540 and board 541 through plated area 564 on board 540 and plated area 565 on board 541. Plated area 564 and plated area 565 can connect to ground or other potential through traces (not shown) on boards 540 and 541. Shield 510 and back plate 550 can be connected, for example to ground, through plated area 552 on a top of board 540 and plated area 553 on a bottom of board 541. Plated area 552 and plated area 553 can connect to ground or other potential through traces (not shown) on boards 540 and 541. RF contact 580 can be connected to a traces on either or both boards 540 and 541 through plated area 584 on a bottom side of board 540. RF contact 580 can connect through these traces to an RF receiver, RF transmitter, RF transceiver, or other circuit (not shown.)

These and other embodiments of the present invention can provide RF contact 580 that can convey various types of high-frequency signals. For example, RF contact 580 can convey Intermediate Frequency (IF) signals, millimeter wave (mmW, mmWave, or MMW) signals (in the range of 30 GHz to 300 GHz), and other RF signals. Millimeter wave signals can be highly directional and have limited over-the-air propagation. As a result, the alignment of RF contact 580 to a corresponding RF contact (not shown) in a connector insert (not shown) can be important. Also for improved signal propagation, the dimensions of RF contact 580, the materials used for RF contact 580 and insulating layer 570, the surface roughness of RF contact 580, and the spacing to shield 510 and ground pad 560 can be tuned. Other contacts, such as power, ground, and signal contacts 522 can be placed away from RF contact 580 and shielded to avoid interference. The RF signal can be routed though connector receptacle 500 to board 540 and board 541, which can be flexible circuit boards, printed circuit boards, or other appropriate substrates. Board 540, board 541, and other associated boards (not shown) can further include tuning elements to improve signal propagation from a first electronic device (not shown) to a second electronic device (not shown.)

FIG. 7A illustrates a front view of the connector receptacle of FIG. 5. In this example, tongue 520 of connector receptacle 500 can be shielded by shield 510. Tongue 520 can include RF contact 580, and boards 540 and 541. Board 540 and board 541 can support contacts 522 on a top and bottom side of tongue 520, respectively. Contacts 522 can be shielded from signals on RF contact 580 by ground pad 560. That is, ground pad 560 can form a shield around RF contact 580. Ground pad 560 can be isolated from RF contact 580 by insulating layer 570. Ground pad 560 and shield 510 can provide shielding for power supplies and signals on contacts 522.

FIG. 7B illustrates an alternative configuration for the connector receptacle of FIG. 5. In this example, tongue 520 of connector receptacle 500 can be shielded by shield 510. Tongue 520 can include RF contact 580, as well as board 540 and board 541. Board 540 and board 541 can support contacts 522 on a top and bottom side of tongue 520, respectively.

As compared to FIG. 7A, ground pad 560 and insulating layer 570 have been split into segments. Top ground pad segment 561 and bottom ground pad segment 562 can shield RF contact 580. Top ground pad segment 561 and bottom ground pad segment 562 can be electrically connected using structures such as side plating (not shown) or vias (not shown) on or through tongue 520. RF contact 580 can be electrically isolated from top ground pad segment 561 and bottom ground pad segment 562 by insulating layer 571 and insulating layer 572.

In these and other embodiments of the present invention, it can be desirable to convey one or more RF or other high-frequency signals. Accordingly, embodiments of the present invention can provide connectors capable of conveying multiple RF or high-frequency signals. Examples are shown in the following figures.

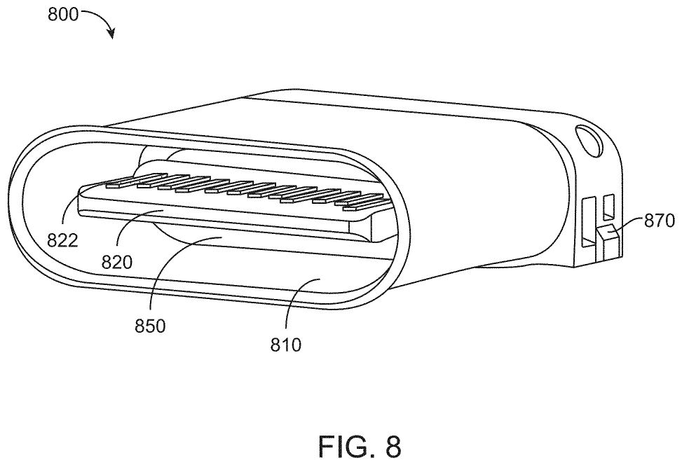

FIG. 8 illustrates a connector receptacle according to an embodiment of the present invention. Connector receptacle 800 can be used as connector receptacle 120 (shown in FIG. 1) above, or as a connector receptacle in other devices that can be improved by in the corporation of an embodiment of the present invention. Connector receptacle 800 can be based on a Universal Serial Bus Type-C connector receptacle. This can give a user a similar feel and experience as using a conventional USB Type-C connector.

Connector receptacle 800 can include tongue 820 surrounded by shielding 810. Tongue 820 can support a number of contacts 822 on a top and bottom side. Housing 850 can support tongue 820. Shielding 810 can be fit to housing 870. Housing 870 can be placed on a printed circuit board (not shown) of an electronic device (not shown) that includes connector receptacle 800. Housing 870, housing 850, and tongue 820 can be formed as individual structures, or two or more of these structures can be formed as a single structure.

Various pinouts can be implemented using this connector to convey one or more RF or high-frequency signals. Examples are shown in the following figures.

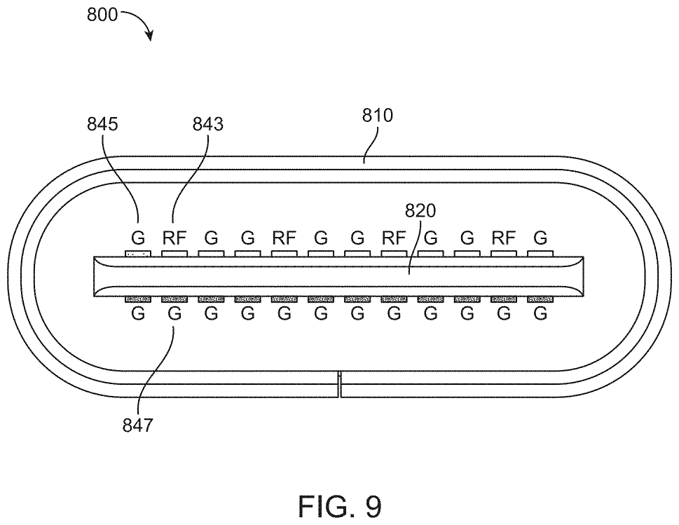

FIG. 9 illustrates a pinout that can be utilized to convey multiple RF or high-frequency signals according to an embodiment of the present invention. In this example, tongue 820 of connector receptacle 800 can support RF contacts 843. RF contacts 843 can each convey an RF or high-frequency signal. In this specific example, four RF contacts 843 are shown, though in these and other embodiments of the present invention, different numbers of RF contacts 843 can be used. Each RF contact 843 can have individual ground contacts 845 on each side, such that two ground contacts 845 are between pairs of RF contacts 843. In these and other embodiments of the present invention, one ground contact 845 can be placed between two RF contacts 843. In this example, a bottom row of contacts can each be a ground contact 847. Shield 810 can provide shielding for external circuits and components from RF contacts 853.

In these and other embodiments of the present invention, one or more ground contacts 845 or 847 can be replaced by an RF contact 843. In these and other embodiments of the present invention, one or more of ground contacts 845 or ground contacts 847 can be replaced with a power supply or other low impedance voltage or AC ground. When this is done, care should be taken that the power supply has a low impedance. This can be achieved using capacitors, wide traces, or other methods.

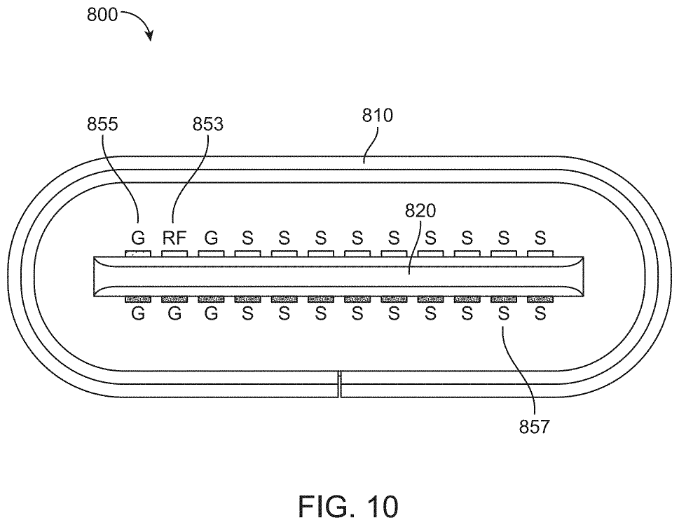

FIG. 10 illustrates another pinout that can be utilized to convey an RF or high-frequency signal according to an embodiment of the present invention. In this example, tongue 820 of connector receptacle 800 can support RF contact 853 surrounded on sides and bottom by ground contacts 855. The remaining contacts 857 can be other signal or power contacts. In this way, RF contact 853 can be physically separated from signal contacts 857 and signal contacts 857 are shielded from a signal on RF contact 853 by ground contacts 855. Shield 810 can provide shielding for external circuits and components from a signal on RF contact 853.

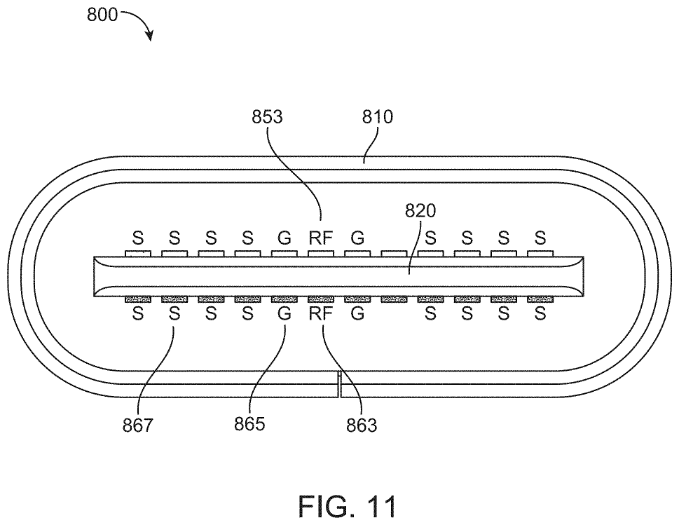

FIG. 11 illustrates another pinout that can be utilized to convey one or more RF or high-frequency signals according to an embodiment of the present invention. In this example, tongue 820 of connector receptacle 800 can support RF contact 853 and RF contact 863. RF contact 853 and RF contact 863 can convey the same or different signals, or they can convey a differential signal. Ground contacts 865 can provide shielding to isolate signal and power contacts 867 from signals on RF contact 853 and RF contact 63. Shield 810 can provide shielding for external circuits and components from signals on RF contact 853 and RF contact 863.

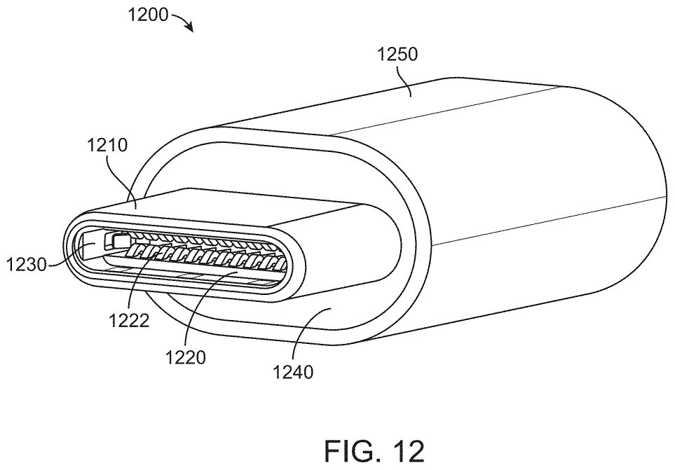

FIG. 12 illustrates a connector insert that can be utilized with a connector receptacle according to an embodiment of the present invention. Connector insert 1200 can be used as connector insert 130 (shown in FIG. 1) above, or as a connector insert in other devices that can be improved by in the corporation of an embodiment of the present invention. In this example, connector insert 1200 can include a number of contacts 1222 supported by housing 1220. Side ground contacts 1230 can physically and electrically contact sides of a tongue (not shown) in a corresponding connector receptacle, such as connector receptacle 200, connector receptacle 500, connector receptacle 800, or other connector receptacle according to an embodiment of the present invention. Housing 1220 can be shielded by shield 1210, which can be supported by housing 1240. Connector insert 1200 can be at least partially enclosed by shell 1250.

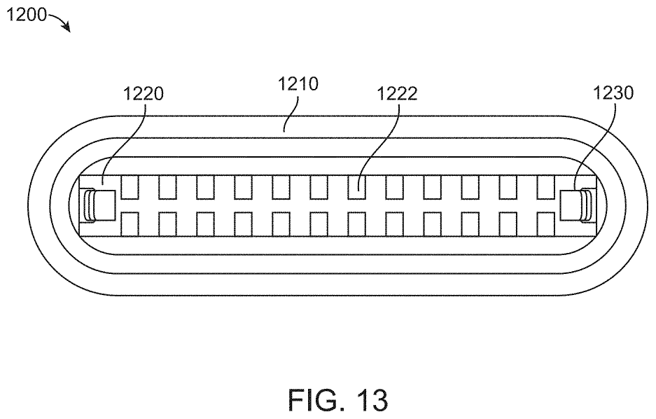

FIG. 13 illustrates a front view of the connector insert of FIG. 12. Connector insert 1200 can include a number of contacts 1222 supported by housing 1220. Side ground contacts 1230 can physically and electrically contact sides of a tongue in a corresponding connector receptacle, such as connector receptacle 200, connector receptacle 500, connector receptacle 800, or other connector receptacle according to an embodiment of the present invention. Shield 1210 can shield external components (not shown) from signals on contacts 1222.

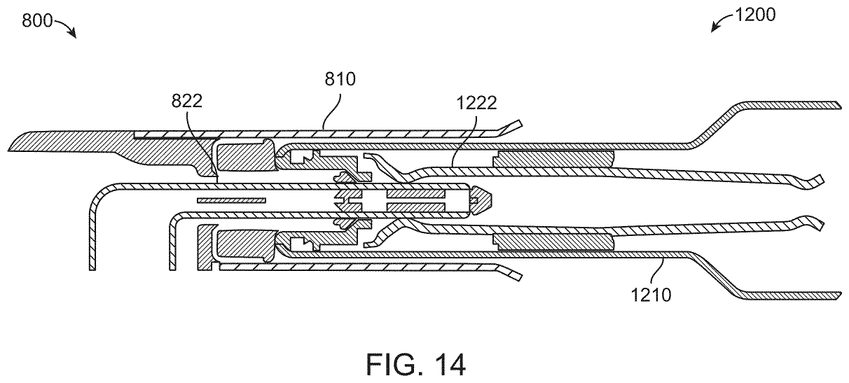

FIG. 14 illustrates a side view of the connector receptacle of FIG. 8 mated with the connector insert of FIG. 12. In this example, contacts 822 in connector receptacle 800 can physically and electrically connect to contacts 1222 in connector insert 1200. Shield 810 of connector receptacle 800 can physically and electrically connect to shield 1210 of connector insert 1200.

In some circumstances, it can be desirable to provide a simplified connector to convey one or more RF signals. Examples are shown in the following figures.

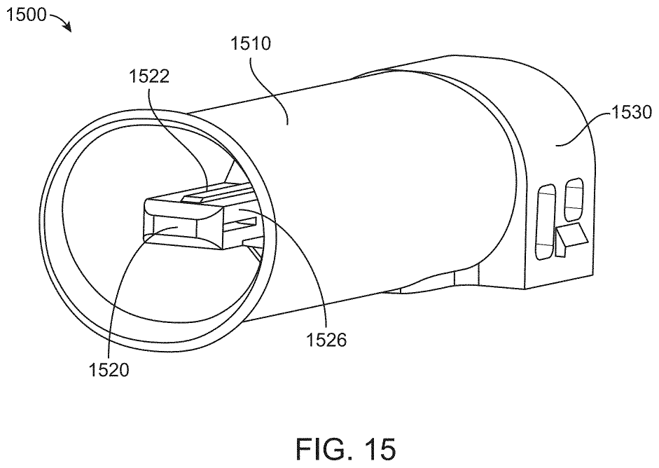

FIG. 15 illustrates a connector receptacle according to an embodiment of the present invention. Connector receptacle 1500 can be used as connector receptacle 120 (shown in FIG. 1) above, or as a connector receptacle in other devices that can be improved by in the corporation of an embodiment of the present invention. Connector receptacle 1500 can be based on a Universal Serial Bus Type-C connector receptacle, where the tongue is reduced to supporting two contacts. This can give a user a similar feel and experience as using a conventional USB Type-C connector.

Connector receptacle 1500 can include tongue 1520 surrounded by shield 1510. Shield 1510 can be connected to housing 1530. Housing 1530 can be supported by a printed circuit board (not shown) in an electronic device (not shown) housing connector receptacle 1500. Tongue 1520 can include side ground contacts 1526 and RF contact 1522. In this example, RF contact 1522 can be the only contact on a top of tongue 1520.

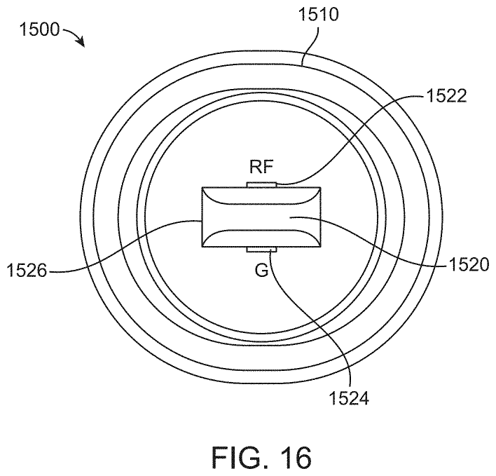

FIG. 16 illustrates a front view of the connector receptacle of FIG. 15. As before, tongue 1520 of connector receptacle 1500 can be surrounded by shield 1510. RF contact 1522 can reside on a top of tongue 1520, while ground contact 1524 can reside on a bottom of tongue 1520. In this example, RF contact 1522 might be the only contact on a top of tongue 1520, while ground contact 1524 might be the only contact on a bottom of tongue 1520. Side ground contacts 1526 can be located on sides of tongue 1520. Ground contact 1524 can instead be utilized as a power supply contact. When this is the case, connector receptacle 1500 could be capable of conveying an RF signal using RF contact 1522, a power supply using ground contact 1524, and ground using side ground contacts 1526.

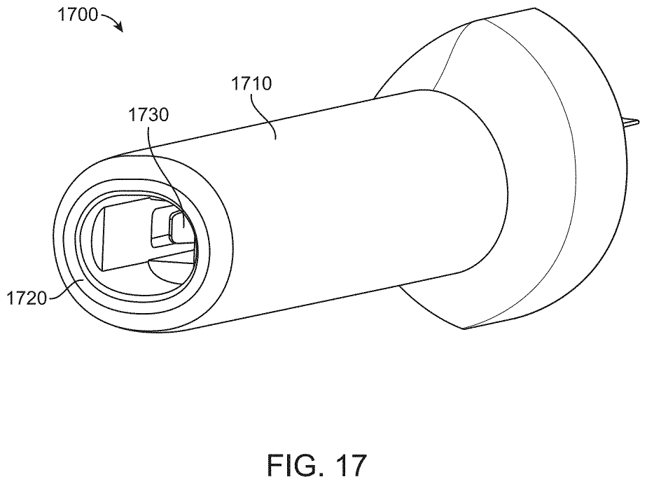

FIG. 17 illustrates a connector insert that can be mated with the connector receptacle of FIG. 15. Connector insert 1700 can be used as connector insert 130 (shown in FIG. 1) above, or as a connector insert in other devices that can be improved by in the corporation of an embodiment of the present invention. Connector insert 1700 can include side ground contacts 1730, which can physically and electrically connect to side ground contacts 1526 in connector receptacle 1500 (shown in FIG. 16.) Side ground contacts 1730 can be supported by housing 1720. Housing 1720 can be shielded by shield 1710.

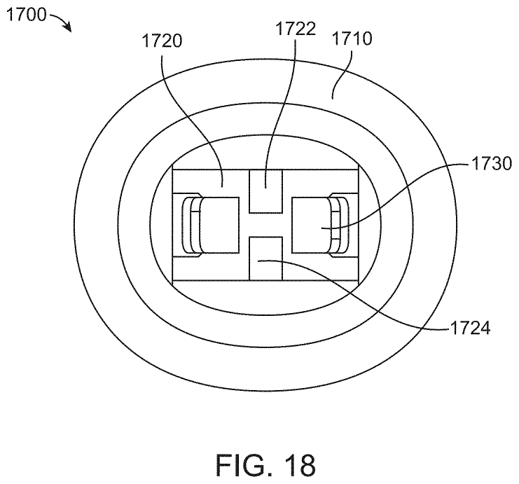

FIG. 18 illustrates a front view of the connector insert of FIG. 17. Connector insert 1700 can include RF contact 1722 and ground contact 1724. Again, ground contacts 1724 can instead be a power supply contact. Side ground contacts 1730 can be supported by housing 1720 and can physically and electrically connect to side ground contacts 1526 of tongue 1520 in connector receptacle 1500 (shown in FIG. 16.) Housing 1720 can be shielded by shield 1710.

In these and other embodiments of the present invention, contacts, ground contacts, ground shields, and other conductive portions of a high-speed connector can be formed by stamping, metal-injection molding, machining, micro-machining, 3-D printing, or other manufacturing process. The conductive portions, such as shields 210 and 510, ground pads 260 and 560, and RF contacts 280 and 580 can be formed of stainless steel, steel, copper, copper titanium, phosphor bronze, or other material or combination of materials. They can be plated or coated with nickel, gold, or other material. The nonconductive portions, such as insulating layers 270 and 290 can be formed using injection or other molding, 3-D printing, machining, or other manufacturing process. The nonconductive portions can be formed of silicon or silicone, rubber, hard rubber, plastic, nylon, liquid-crystal polymers (LCPs), or other nonconductive material or combination of materials. Boards, such as boards 240, 541, and 541, can be formed using FR-4 or other appropriate material.

Embodiments of the present invention can provide high-speed connectors that can be located in various types of devices, such as portable computing devices, tablet computers, desktop computers, laptops, all-in-one computers, cell phones, wearable-computing devices, storage devices, portable media players, navigation systems, monitors, power supplies, adapters, remote control devices, chargers, and other devices. These high-speed connectors can provide pathways for signals that are compliant with various standards such as Universal Serial Bus (USB), a High-Definition Multimedia Interface (HDMI), Digital Visual Interface (DVI), power, Ethernet, DisplayPort, Thunderbolt, Lightning and other types of standard and non-standard interfaces that have been developed, are being developed, or will be developed in the future.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector comprising:
a tongue;
a first plurality of contacts located on a top the tongue and a second plurality of contacts located on a bottom of the tongue;
a top ground pad segment on the top of the tongue such that the first plurality of contacts are between the top ground pad segment and a front edge of the tongue;
a bottom ground pad segment on the bottom of the tongue such that the second plurality of contacts are between the bottom ground pad segment and the front edge of the tongue;
a top radio-frequency (RF) contact segment located on a top of the tongue and extending from a first side of the tongue to a second side of the tongue, the first side of the tongue and the second side of the tongue between the top of the tongue and the bottom of the tongue;
a bottom RF contact segment located on a bottom of the tongue and extending from the first side of the tongue to the second side of the tongue; and
a shield around the tongue, the first plurality of contacts, the second plurality of contacts.

2. The connector of claim 1 wherein the top ground pad segment, the bottom ground pad segment, and the shield form shielding for the top RF contact and the bottom RF contact.

3. The connector of claim 2 wherein the top ground pad segment and the bottom ground pad segment are segments of a ground pad that encircles the tongue.

4. The connector of claim 3 wherein the top RF contact segment and the bottom RF contact segment are segments of an RF contact that encircles the tongue.

5. The connector of claim 4 further comprising a first insulating layer between the ground pad and the RF contact.

6. The connector of claim 5 further comprising a second insulating layer between the shield and the RF contact.

7. The connector of claim 6 wherein the tongue comprises a board, the board having a frame along the front edge of the tongue, the first side of the tongue, and the second side of the tongue.

8. A connector comprising:
a tongue;
a first plurality of contacts located on a top the tongue and a second plurality of contacts located on a bottom of the tongue;
a radio-frequency (RF) contact located in the center of the tongue;
a top ground pad segment on the top of the tongue such that the top ground pad segment is between the first plurality of contacts and a front edge of the tongue;
a bottom ground pad segment on the bottom of the tongue such that the bottom ground pad segment is between the second plurality of contacts and a front edge of the tongue; and
a shield around the tongue, the first plurality of contacts, the second plurality of contacts.

9. The connector of claim 8 wherein the top ground pad segment and the bottom ground pad segment form shielding for the RF contact.

10. The connector of claim 9 wherein the top ground pad segment and the bottom ground pad segment are segments of a ground pad that encircles the tongue.

11. The connector of claim 10 further comprising a first insulating layer between the ground pad and the RF contact.

12. The connector of claim 11 wherein the tongue comprises a top board and a bottom board, the top board supporting the first plurality of contacts and the bottom board supporting the second plurality of contacts.

13. The connector of claim 12 wherein the RF contact is between the top board and the bottom board.

14. The connector of claim 13 further comprising a plurality of electrical components positioned between the top board and the bottom board.

15. A connector system comprising:
a connector receptacle comprising:
a tongue;
a first radio-frequency (RF) contact on a top of the tongue;
a first ground contact on a bottom of the tongue; and
a shield around the tongue.

16. The connector system of claim 15 wherein the first RF contact is the only contact on the top of the tongue.

17. The connector system of claim 16 wherein the first ground contact is the only contact on the bottom of the tongue.

18. The connector system of claim 17 further comprising:
a connector insert comprising:
a housing, the housing supporting:
a second RF contact to connect to the first RF contact when the connector insert is mated with the connector receptacle;
a second ground contact to connect to the first ground contact when the connector insert is mated with the connector receptacle;
a first side ground contact to connect to a side of the tongue when the connector insert is mated with the connector receptacle; and
a second side ground contact to connect to a side of the tongue when the connector insert is mated with the connector receptacle; and
a shield around the housing to connect the shield of the connector receptacle when the connector insert is mated with the connector receptacle.

19. The connector system of claim 18 wherein the second RF contact is the only contact supported by a top of the housing.

20. The connector system of claim 19 wherein the second ground contact is the only contact supported by a bottom of the housing.
